(19) United States
(12) Patent Application Publication
(10) Pub. No.: US 2026/0189934 A1
(43) Pub. Date: Jul. 2, 2026

(54) TOPOLOGY CONTROL SYSTEM AND CONTROL METHOD FOR DYNAMIC NETWORK

(71) Applicant: Xidian University, Xi'an (CN)

(72) Inventors: Changle Li, Xi'an (CN); Yunfeng Zhang, Xi'an (CN); Wengang Li, Xi'an (CN); Peiang Zuo, Xi'an (CN); Yuteng Qi, Xi'an (CN); Liuyan Yang, Xi'an (CN)

(21) Appl. No.: 19/008,604

(22) Filed: Jan. 2, 2025

(51) Int. Cl. H04W 24/02; H04W 84/18

(52) U.S. Cl. CPC H04W 24/02; H04W 84/18

(57) ABSTRACT

A topology control system and a corresponding topology control method for dynamic network is provided. The topology control system for dynamic network includes a sensing module, a data processing module, a data judgment module, a communication module and a central module. The sensing module collects the data of the surrounding nodes, and transmits it to the data processing module for caching, and then selects the cluster head of the current node according to the data, and then transmits it to the data judgment module. After the data judgment module checks the cluster head qualified, the communication module is responsible for wireless transmission of cluster head information to the central module. The central module collects the data of all nodes in the network and transmits the results to the client. It can be used for topology control of the dynamic network.

### TECHNICAL FIELD

The present disclosure relates to the field of communication technology, and further relates to a node topology control system and method, which can be used for a dynamic network composed of mobile nodes.

### BACKGROUND

Ad-Hoc network is composed of dozens or hundreds of nodes equipped with sensing devices, computing devices and communication devices, which are connected by wireless communication. It is a network system that can quickly expand applications without establishing fixed infrastructure in advance. In Ad-Hoc network, the nodes cooperate with each other, each node selects its neighbor nodes which within its communication range to establish a connection, and forms a network to meet the connectivity through network clustering, multi-hop transmission and other means.

For the Ad-Hoc network composed of automobile, ship, unmanned aerial vehicle (UAV) and other nodes, the high-speed movement of nodes may cause the connected nodes in the network to leave each other's communication range in a short time, resulting in intermittent signals. The failure to connect stably for a long time will inevitably affect the stability and robustness of the network. Increasing the transmission power can increase the communication range of nodes and prolong the connection time of nodes, but it will also increase the energy loss of nodes, and interfere with the communication of other nodes, resulting in the shortening of network life cycle and the decline of communication quality. The reasonable topology control method can maintain the stability of the connection in the scene of high-speed mobile nodes, improve the network throughput and reduce the interference.

Network topology control systems and control methods have attracted more attention and research, but the existing methods are inadequate. On the one hand, most of the existing network topology control technologies are aimed at the network with static nodes. The main purpose of these methods is to reduce the energy consumption of nodes and prolong the life cycle of the network. The main basis for these methods to establish and adjust the network topology is the residual energy value of nodes. However, for the network composed of dynamic nodes such as automobile, ship and UAV, these nodes can load large capacity power supply equipment, so the residual energy value of nodes is no longer the main factor limiting the network quality, nor should it be the main purpose of network topology control method. In addition, the high-speed movement of nodes causes the network to change rapidly, the topology control system and method for static network do not consider this factor, which will cause frequent connection switching between nodes and affect the stability and reliability of the network. On the other hand, the existing topology control systems and methods for dynamic networks usually choose centralized architecture or distributed architecture. For the topology control system with central architecture, the center node of the network needs to run the algorithm with high complexity, which is almost responsible for the maintenance and update of the whole network. As a result, the center of the network needs to bear great load, and with the continuous expansion of the network scale, the computing load and communication load of the center node increase rapidly, which is not conducive to the network load balancing and scalability. Besides, once the center node is disturbed or destroyed, all nodes in the network can not work normally, which causes the paralysis of the whole network and reduces the robustness and anti-interference ability of the network. For the distributed topology control system, the network can achieve load balancing and has high robustness, but the nodes in the network work independently and can not cooperate well and efficiently, which brings great difficulties to the data fusion and unified scheduling of the network.

In order to maximize the stability of the dynamic network connection, ensure the load balance and robustness of the network and improve the cooperation ability of network nodes at the same time, it is an urgent technical problem to design a topology control system suitable for dynamic nodes and its control method.

### SUMMARY

The object of the present disclosure is to provide a topology control system for dynamic network and corresponding topology control method aiming at the deficiency of existing network topology control technology, so as to effectively improve the stability and reliability of dynamic network communication and enhance the cooperation ability between network nodes.

To achieve the above object, the technical solution of the present disclosure is as follows:

1. A topology control system of dynamic network, including a sensing module, a data processing module, a data judgment module, a communication module and a central module, wherein the sensing module, the data processing module, the data judgment module and the communication module are integrated in a current node, and the sensing module, the data judgment module and the communication module are wired connected with the data processing module respectively, and the communication module is connected with the central module wirelessly.

The sensing module is used for sensing data and transmitting the data sensed by the sensor to the data processing module.

The data processing module is configured to receive the data sensed by the sensing module for caching, select a cluster head of the current node according to the cached data and upload the cluster head to the data judgment module, and then wait for the data judgment module to check the rationality of the cluster head and receive the test results. If the received results show that the cluster head selection is reasonable, the data processing module sends the cluster head information to the communication module, otherwise, the data processing module selects the cluster head again.

The data judgment module is configured to analyze the data transmitted by the data processing module, judge whether the cluster head selection is reasonable, and feed back the result to the data processing module.

The communication module is configured to monitor the data sent by the data processing module and send the data to the central module after receiving the data.

The central module is configured to summarize the data sent by all nodes in the network and sending processing results to the client.

2. A topology control method suitable for dynamic networks, the method includes the following steps:
step 1) initializing a dynamic network waiting for topology control;
step 2) finding neighbor nodes of each node and calculating a similarity matrix of the network;
step 3) classifying the nodes in the network, and calculating an attraction matrix of the network according to the node level and the similarity matrix;
step 4) calculating a node belonging matrix of the network according to the attraction matrix of the network, and determining a cluster head of each node, that is, the node corresponding to the column where the first element is “1” in the corresponding row of the belonging matrix is taken as the cluster head to form the topology of the network;
step 5) calculating the optimal transmission power of each node, and judging whether the network topology meets the connectivity requirements. If it meets the requirements, completing the current stage of network topology control, and execute step 6); otherwise, return to step 4);
step 6) monitoring the status of the node and judging whether there is a node moving; if there is a node moving, return to step 2) for a new round of network topology control, otherwise, maintain the current network topology and monitor continuously.

Compared with the prior art, the present disclosure has the following advantages:

First, it can improve the stability of dynamic network. The present disclosure can construct the network topology according to the dynamic characteristics of the nodes, compared with the existing static network topology control algorithm, the present disclosure can ensure the reliable connection and topology stability of the dynamic network for a long time, improve the throughput and stability of the network, and is suitable for broader scenarios.

Second, load balancing and strong robustness. The network topology control method and the network topology control system of the present disclosure adopt the distributed architecture, each node makes decisions independently according to the sensing information, so as to flexibly adjust the connection relationship with the adjacent nodes, which does not need the unified deployment of the center node, reduces the load of the center node, and improves the anti-interference ability of the network.

Third, the adjustment is flexible and the network is adaptable. The present disclosure can flexibly adjust the topological relationship and transmission power of the nodes according to the real-time situation of the network, and has strong adaptability to the environmental changes of the network.

Fourth, energy consumption saving and interference reduction. The present disclosure can control the optimal transmission power of each node under the condition of stable network, reduce the node energy consumption of dynamic network, prolong the network life cycle, and reduce the mutual interference between different nodes of the network.

Fifth, the ability of network cooperation is improved and easy to manage. The topology control method for dynamic network provided by the present disclosure is optimized and improved on the basis of the traditional distributed architecture. By means of node grading and network clustering, it can avoid the problems of high load of the center node caused by the expansion of the network scale and the whole network paralysis caused by the interference and damage of the center node, at the same time, it improves the cooperation ability between network nodes, and is easy to maintain and manage the whole network.

### BRIEF DESCRIPTION OF THE DRAWINGS

In order to more clearly illustrate the technical solution of the embodiment of the present disclosure, the drawings needed to be used in the description of the embodiments will be briefly introduced. It is apparent that the drawings described below are some embodiments of the disclosure. For ordinary skilled person in the art, other drawings can be obtained according to these drawings without paying creative labor.

FIG. 1 is a schematic diagram of the node topology control system of the present disclosure;

FIG. 2 is the working principle diagram of the data processing module in the node topology control system of the present disclosure;

FIG. 3 is the flow chart of the node topology control method of the present disclosure.

### DETAILED DESCRIPTION OF THE EMBODIMENTS

The following will clearly and completely describe the embodiments of the present disclosure in combination with the drawings. It is apparent that the described embodiments are part of the embodiments of the present disclosure, not all of them. Based on the embodiments in the present disclosure, all other embodiments obtained by ordinary skilled person in the art without making creative work are within the scope of the present disclosure.

The present disclosure mainly aims at the topology control problem of dynamic network, and provides a network topology control method suitable for mobile nodes and a corresponding network topology control system. The network topology control method and network topology control system can adjust the connection relationship and topology structure of the network nodes in real time according to the status of the nodes. While ensuring the network connectivity, the power control of the nodes can save the energy consumption of the network and reduce the interference in the network. The distributed deployment system can improve the robustness and anti-strike capability of the network.

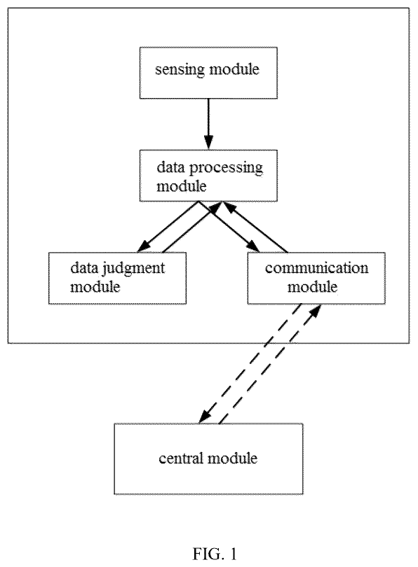

Referring to FIG. 1, the dynamic network topology control system of the present disclosure includes a sensing module 1, a data processing module 2, a data judgment module 3, a communication module 4 and a central module 5. The sensing module 1, the data processing module 2, the data judgment module 3 and the communication module 4 are integrated in each node. The sensing module 1, the data judgment module 3 and the communication module 4 are wired connected with the data processing module 2 respectively. And the communication module 4 is wireless connected with the central module 5. The sensing module 1 is responsible for sensing data and transmitting the sensed data to the data processing module 2. The data processing module 2 processes the data sent by the sensing module, calculates and selects the cluster head of the current node, and interacts with the data judgment module 3 and the communication module 4. The data judgment module 3 is responsible for judging whether the cluster head selected by the data processing module 2 is reasonable, and feedback the result to the data processing module 2. The communication module 4 receives the cluster head information transmitted by the data processing module 2 and sends this information to the central module 5.

The sensing module 1 is mainly composed of sensors and a power supply device. The sensors of the module mainly include: a distance sensor, a speed sensor, and other selective sensors. The selective sensor is selected by the user according to the business scenario. The module is mainly responsible for sensing the neighbor node information and service sensitive information, including but not limited to the neighbor node coordinates, moving direction and speed.

The data processing module 2 is the core module of the node topology control system of the present disclosure, which is respectively wired connected with the sensing module 1, the data judgment module 3 and the communication module 4, and is mainly composed of a computing unit and a power supply device.

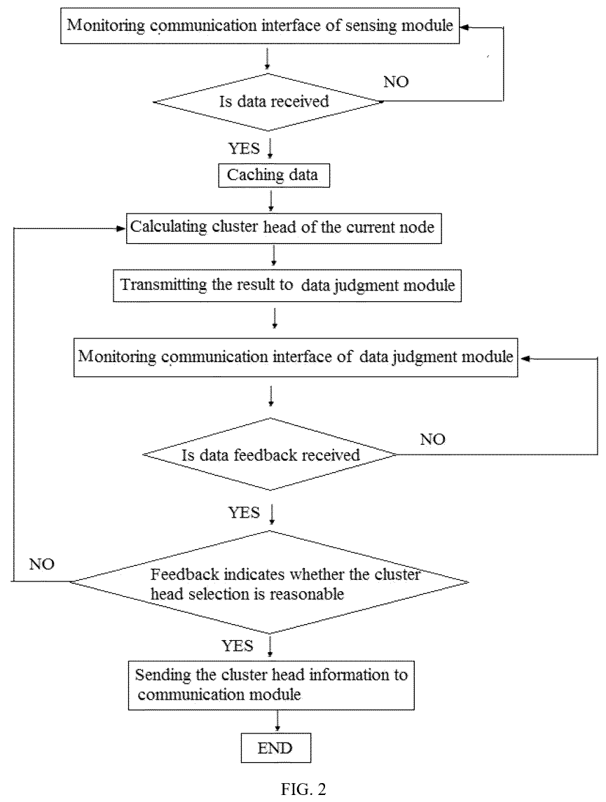

Referring to FIG. 2, the processing flow of the data processing module 2 includes:
Step 1) the communication interface with the sensing module 1 is monitored until the data transmitted by the sensing module 1 is received.
Step 2) the data transmitted by the sensing module 1 is cached locally.
Step 3) the attraction matrix, the similarity matrix and the node belonging matrix of the network are calculated, and the cluster head is established for the current node according to the node belonging matrix.
Step 4) the calculated cluster head information is sent to the data judgment module 3.
Step 5) in the waiting state, the communication interface with the data judgment module 3 is continuously monitored until the feedback sent by the data judgment module 3 is received.
Step 6) after receiving the feedback information from the data judgment module 3, the judgment result is extracted; if the result shows that the cluster head selection is reasonable, execute step 7), otherwise, return to step 3).
Step 7) the cluster head information is sent to the communication module 4.

The data judgment module 3 is mainly composed of a data processing unit and a power supply device. The module is wired connected to the data processing module 2, which is mainly responsible for monitoring the communication interfaces between the data processing module 2, receiving the data transmitted by the data processing module 2, and judging whether the cluster head selection is reasonable, including but not limited to the judgment of network connectivity, and then feedback the judgment results to the data processing module 2.

The communication module 4 is used to establish a connection with the central module and wireless transmission of the information to the central module after receiving the data sent by the data processing module 2. The technology used in the transmission is mainly wireless technology, including but not limited to a series of wireless technologies such as Bluetooth, Wi Fi and so on.

The central module 5 mainly refers to the center node or base station of the network, which is responsible for collecting the information transmitted by the network nodes and processing the corresponding data according to the business requirements, including but not limited to data fusion, data filtering, etc., and finally transmitting the processing results to the client.

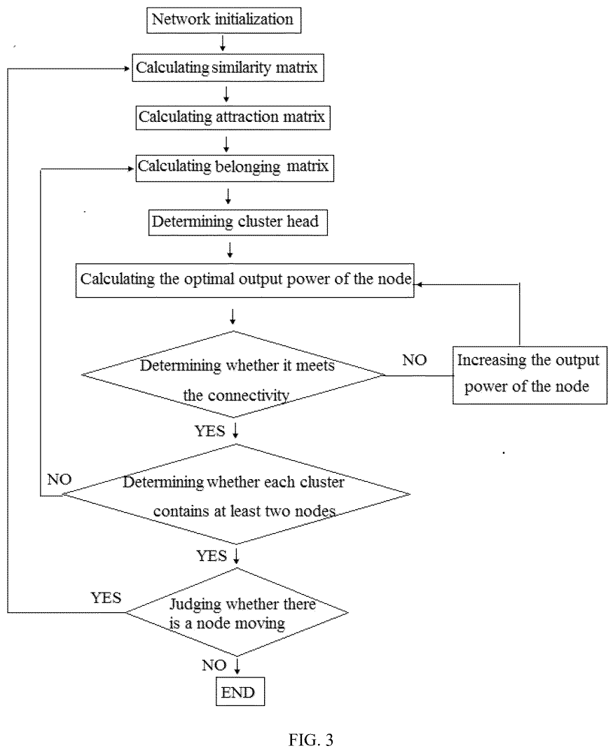

Referring to FIG. 3, the network topology control method of the present disclosure includes the following steps:
Step 1, initializing the dynamic network waiting for topology control.

In the initialization phase of the network, each node will generate a unique number to identify the node, including but not limited to the monotonic incremental numbering method, with the value of 1−N, wherein N is the total number of nodes in the dynamic network. Further, this stage also needs to initialize the attraction matrix, the similarity matrix and the node belonging matrix of the dynamic network to be topology controlled. The size of the above matrix is N*N, N is the total number of nodes in the dynamic network, and the initial value of each element in the matrix is 0.
Step 2, finding neighbor nodes of each node, and calculating the similarity matrix of the network.
2.1) When a node is searching for its neighbor node, it can use broadcast or location method. If it uses broadcast method, it will broadcast its own information to the surrounding nodes with a certain power and wait for the response from the surrounding nodes. After receiving the response from other nodes, it can determine the responding nodes as its neighbor nodes. If the location method is adopted, a distance threshold should be determined first, and the nodes whose distance is less than the threshold should be determined as the neighbor nodes.
2.2) Calculating the similarity between each node and all its neighbor nodes respectively. The formula for calculating the similarity sᵢⱼ of the node i and the node j is as follows:

$${s}_{ij} = \{ \begin{matrix}1 / [ {d}_{ij}^{2} + {\vert {v}_{ij} \vert}^{2} ] , i \neq j \\ 1 / [ {d}_{ic}^{4} + {\vert {v}_{ic} \vert}^{2} ] , i = j\end{matrix} ,$$

Wherein, d is the Euclidean distance from the i th node to the j th node at the current time, if the i th node to the j th node are not adjacent to each other, the Euclidean distance dᵢⱼ can be set as positive infinity; di is the Euclidean distance from the current i th node to the center node or base station C; vᵢⱼ is the velocity vector difference between the current i th node and the j th node; v_{ic} is the velocity vector difference between the current i th node and the center node or the base station c.

In this embodiment, it is assumed that the nodes are distributed on the two-dimensional plane, and similar calculation method can be used for the three-dimensional space. Through the calculation method of this step, it can be inferred that the closer the distance between the two nodes is, the smaller the modulus of velocity vector difference is, the higher the similarity between the two nodes is. At the same time, each node also needs to calculate its similarity with the center node or the base station, which lays the foundation for the selection of cluster head in the future. This step fully considers the dynamic characteristics of the network, and is suitable for the scene where the center node or the base station is in the mobile state.
2.3) After all nodes have completed the similarity calculation with their neighbor nodes, the similarity matrix with the size of N×N, which is composed of the similarity values between each node as follows:

$$S = [ \begin{matrix}{s}_{11} & {s}_{12} & … & {s}_{1 N} \\ {s}_{21} & {s}_{22} & … & {s}_{2 N} \\ ⋮ & ⋮ & ⋮ & ⋮ \\ {s}_{N 1} & {s}_{N 2} & … & {s}_{NN}\end{matrix} ] ,$$

Wherein, N is the total number of nodes in the dynamic network.
Step 3, classifying the nodes in the network, and calculating the attraction matrix of the network according to the node level and the similarity matrix.
3.1) Dividing the network into different levels according to different application scenarios;

In this embodiment, it is assumed that the smaller the level number of a node, the higher the level of the node in the network, and the minimum is 1. The level 1 usually represents the center node or the base station of the network. The basis for dividing the network level includes but is not limited to the communication ability and the computing ability of the node, and different weights can be given to each factor according to a variety of application scenarios. For this embodiment, the smaller the level number of the node is, the stronger the communication ability and the computing ability it usually has, so it can bear heavier loads.
3.2) Calculating the attractiveness of each node to all its neighbor nodes respectively. The formula for calculating the attractiveness aᵢⱼ of the node j to the node i is as follows:

$${a}_{ij} = ( {l}_{i} - {l}_{j} ) \cdot {s}_{ij} ,$$

Wherein, lᵢ is the level of the i th node in the network; lⱼ is the level of the j th node in the network; sᵢⱼ is the similarity between the i th node and the j th node; the greater the attractiveness, the greater the probability of joining the cluster where the node is located.
3.3) After all nodes have completed the attractiveness calculation with their neighbor nodes, the attraction matrix A with the size of N×N, which is composed of the attractiveness values of each node as follows:

$$A = [ \begin{matrix}{a}_{11} & {a}_{12} & … & {a}_{1 N} \\ {a}_{21} & {a}_{22} & … & {a}_{2 N} \\ ⋮ & ⋮ & ⋮ & ⋮ \\ {a}_{N 1} & {a}_{N 2} & … & {a}_{NN}\end{matrix} ] ,$$

Wherein, N is the total number of nodes in the dynamic network.
Step 4, Calculating the node belonging matrix of the network according to the attraction matrix of the network, and determining the cluster head of each node.
4.1) Calculating the belonging factors bᵢⱼ of each node to all neighbor nodes, and the formula for calculating the belonging factor bᵢⱼ of node j to node i is as follows:

$${b}_{i j} = \{ \begin{matrix}0 , {a}_{ij} \neq max ( {a}_{ik} ) 1 \leq k \leq N \\ 1 , {a}_{ij} = max ( {a}_{ik} ) 1 \leq k \leq N\end{matrix} ,$$

Wherein, i, j and k are node numbers; aᵢⱼ is the attraction degree of node j to node i; N is the total number of nodes in the dynamic network.
4.2) After all the nodes have completed the calculation of the belonging factors with their neighbor nodes, the belonging matrix B with the size of N×N, which is composed of the belonging factors of each node as follows:

$$B = [ \begin{matrix}{b}_{11} & {b}_{12} & … & {b}_{1 N} \\ {b}_{21} & {b}_{22} & … & {b}_{2 N} \\ ⋮ & ⋮ & ⋮ & ⋮ \\ {b}_{N 1} & {b}_{N 2} & … & {b}_{NN}\end{matrix} ] ;$$

4.3) After calculating the belonging matrix of the network, it is necessary to further select the cluster head of each node. The specific selection rule adopted in this embodiment is that the cluster head of each node is the node number corresponding to the column of the first “1” element in the corresponding row of the belonging matrix. After each node establishes the cluster head, it will send the connection request to the cluster head and establish the connection. After all nodes establish the cluster head, the topology of the network is established.
Step 5, calculating the optimal transmission power of each node, and judging whether the network topology meets the connectivity requirements.
5.1) Calculating the optimal transmission power of each node. The method for calculating the optimal transmission power of each node in this embodiment is that for an ordinary node, the optimal transmission power of the node is the power required for stable communication with the cluster head; for the cluster head node, the optimal transmission power of the node is the power required for stable communication with the center node or base station and the cluster member with the farthest Euclidean distance at the same time;
5.2) Judging the connectivity of the network topology. If all nodes in the network can communicate with the center node or base station in a one hop or multi-hop manner according to the network topology control method provided in the present disclosure, it indicates that the network topology meets the connectivity requirements, and completes the network topology control at the current stage, execute step 6); otherwise, it is necessary to increase the transmission power of the node that does not meet the requirements, and return step 4) until the requirements are met.

The methods to judge whether the network meets with connectivity include but are not limited to the depth-first search algorithm and the breadth-first search for a graph.
Step 6, updating the topology of the network.

The movement of nodes will lead to the change of network state. In this embodiment, the node information is obtained in real time through the sensing module, and the attraction matrix, the similarity matrix and the node belonging matrix of the network are constantly updated, so as to update the topology structure of the network and ensure the long-term effective connectivity and stability of the network, and its realization is as follows:

Monitoring the status of the node, and judging whether there is a node moving: if there is a node moving, return step 2) for a new round of network topology control; otherwise, maintain the current network topology and monitor continuously.

The present disclosure realizes the overall goal of load balancing, strong robustness, energy saving and interference reduction, adopts the topology control method realized by the distributed architecture system to meet the topology requirements of the dynamic network, is suitable for high-speed mobile nodes, and plays a vital role in the stable connection and reliable transmission of the dynamic network. The dynamic network topology control system provided by the present disclosure updates the node information and status in real time and adjusts the network topology structure in time through the cooperation of the sensing module, the data processing module, the data judgment module and the communication module. In addition, the optimal power selection strategy can further save energy consumption, reduce internal interference and ensure the long-term stability of network communication.

The description above is only the specific embodiment of the present disclosure, but the scope of the present disclosure is not limited to this. Any skilled person in the art can easily think of various equivalent modifications or substitutions within the technical scope of the present disclosure, and these modifications or substitutions should be included in the scope of the present disclosure. Therefore, the scope of the present disclosure shall be subject to the scope of the claims.

1. A dynamic network topology control system, comprising a sensing module (1), a data processing module (2), a data judgment module (3), a communication module (4) and a central module (5), wherein the sensing module (1), the data processing module (2), the data judgment module (3) and the communication module (4) are integrated in a current node, and the sensing module (1), the data processing module (2), the data judgment module (3) and the communication module (4) are respectively wired connected with the data processing module (2), and the communication module (4) is wirelessly connected with the central module (5);
the sensing module (1) is configured to sense data and transmit the data sensed by sensors to the data processing module (2);
the data processing module (2) is configured to receive the data transmitted by the sensing module (1) for caching, select a cluster head of the current node according to the data in the cache and upload the cluster head to the data judgment module (3), and then wait for the data judgment module (3) to check the rationality of the cluster head and receive the test results; if the received result indicates that the cluster head selection is reasonable, the data processing module (2) sends the cluster head information to the communication module (4), otherwise, the data processing module (2) selects the cluster head again;
the data judgment module (3) is configured to analyze the data transmitted by the data processing module (2), judge whether the cluster head selection is reasonable, and feed back the result to the data processing module (2);
the communication module (4) is configured to monitor the data sent by the data processing module (2) and send the data to the central module (5) after receiving the data;
the central module (5) is configured to summarize the data sent by all nodes in the network and send processing results to a client.

2. The system according to claim 1, wherein the sensor of the sensing module (1) comprises a distance sensor, a speed sensor and a selective sensor, wherein the selective sensor is selected by an user according to demands of a service.

3. The system according to claim 1, wherein an attraction matrix, a similarity matrix and a node belonging matrix of the network are calculated in sequence by the data processing module (2), and the optimal transmission power of the current node is determined according to the node belonging matrix.

4. The system according to claim 1, wherein the data transmitted by the data processing module (2) is analyzed by the data judgment module (3), comprising two aspects: one is to monitor interfaces between the data processing module (2), until the data uploaded by the data processing module is received; the other one is to judge whether the network meets a connectivity requirements, inform the data processing module (2) of a judgment result, and continue monitoring.

5. A topology control method for dynamic network, comprising
step 1) initializing a dynamic network waiting for topology control;
step 2) finding neighbor nodes of each node and calculating a similarity matrix of the network;
step 3) classifying the nodes in the dynamic network, and calculating an attraction matrix of the network according to levels of the nodes and the similarity matrix;
step 4) calculating a node belonging matrix of the network according to the attraction matrix of the network, and determining a cluster head of each node, that is, the node corresponding to a column where a first element is “1” in a corresponding row of the belonging matrix is taken as the cluster head to form a topology of the network;
step 5) calculating an optimal transmission power of each node, and judging whether the topology of the network meets a connectivity requirement; if the topology of the network meets the connectivity requirement, completing a current stage of network topology control, and execute step 6); otherwise, return to step 4);
step 6) monitoring a status of the node and judging whether there is a node moving; if there is a node moving, return to step 2) for a new round of network topology control, otherwise, maintaining the current network topology and continuously monitoring.

6. The method according to claim 5, wherein the step 1) of initializing a dynamic network waiting for topology control is to generate a unique number for each node of the network, and a value is 1−N, wherein N is the total number of nodes in the dynamic network, and an initial value of each element of the similarity matrix, the attraction matrix and the node belonging matrix is 0.

7. The method according to claim 5, wherein the step of calculating the similarity matrix of dynamic network in step 2) is realized as follows:
calculating a similarity sᵢⱼ of node i and node j by a following formula firstly:
$${s}_{ij} = \{ \begin{matrix}1 / [ {d}_{ij}^{2} + {\vert {v}_{ij} \vert}^{2} ] , i \neq j \\ 1 / [ {d}_{ic}^{4} + {\vert {v}_{ic} \vert}^{2} ] , i = j\end{matrix}$$
Wherein, dᵢⱼ is an Euclidean distance from the i th node to the j th node at a current time, if the i th node to the j th node are not adjacent to each other, the Euclidean distance dᵢⱼ can be set as positive infinity; d_{ic} is an Euclidean distance from the current i th node to a center node or a base station C; vᵢⱼ is a velocity vector difference between the current i th node and the j th node; v_{ic} is a velocity vector difference between the current i th node and the center node or the base station c;
then, constructing the similarity matrix with the size of N×N which is composed of the similarities between the nodes as follows:
$$S = [ \begin{matrix}{s}_{11} & {s}_{12} & … & {s}_{1 N} \\ {s}_{21} & {s}_{22} & … & {s}_{2 N} \\ ⋮ & ⋮ & ⋮ & ⋮ \\ {s}_{N 1} & {s}_{N 2} & … & {s}_{NN}\end{matrix} ]$$
wherein, N is the total number of the nodes in the dynamic network.

8. The method according to claim 5, wherein the step of classifying the nodes in the dynamic network in step 3) is that classifying the nodes in the dynamic network into different levels according to different application scenarios, the smaller the level number is, the higher the level of the node in the network is, and the minimum is 1, that is, the level 1 represents a center node or a base station in the network.

9. The method according to claim 5, wherein the step of calculating the attraction matrix of the dynamic network in step 3) is realized as follows:
calculating an attractiveness aᵢⱼ of node j to node i by a following formula firstly:
$${a}_{ij} = ( {l}_{i} - {l}_{j} ) \cdot {s}_{ij}$$
wherein, lᵢ is a level of the i th node in the network; lⱼ is a level of the j th node in the network; sᵢⱼ is a similarity between the i th node and the j th node;
then, constructing the attractiveness matrix with the size of N×N which is composed of the attractiveness of each node as follows:
$$A = [ \begin{matrix}{a}_{11} & {a}_{12} & … & {a}_{1 N} \\ {a}_{21} & {a}_{22} & … & {a}_{2 N} \\ ⋮ & ⋮ & ⋮ & ⋮ \\ {a}_{N 1} & {a}_{N 2} & … & {a}_{NN}\end{matrix} ]$$
wherein, N is the total number of the nodes in the dynamic network.

10. The method according to claim 5, wherein the step of calculating the node belonging matrix of the dynamic network in step 4) is realized as follows:
calculating a belonging factor b ij of the i th node to the j th node by a following formula firstly:
$${b}_{i j} = \{ \begin{matrix}0 , {a}_{ij} \neq max ( {a}_{ik} ) and 1 \leq k \leq N \\ 1 , {a}_{ij} = max ( {a}_{ik} ) and 1 \leq k \leq N\end{matrix} ,$$
wherein, i, j and k are node numbers; ay is an attractiveness of node j to node i; N is the total number of the nodes in the dynamic network;
then, constructing the belonging matrix with the size of N×N which is composed of the belonging factors of each node as follows:
$$B = [ \begin{matrix}{b}_{11} & {b}_{12} & … & {b}_{1 N} \\ {b}_{21} & {b}_{22} & … & {b}_{2 N} \\ ⋮ & ⋮ & ⋮ & ⋮ \\ {b}_{N 1} & {b}_{N 2} & … & {b}_{NN}\end{matrix} ] .$$
